(19) United States
(12) Patent Application Publication
(10) Pub. No.: US 2014/0227028 A1
(43) Pub. Date: Aug. 14, 2014

(54) Centrifugal Pump Connection Device for Electrical Submersible Pump Unit

(71) Applicants: Pin Wu, Beijing (CN); Hai Zhou, Beijing (CN); Yuliang Shen, Beijing (CN); Houwei Xing, Beijing (CN); Heng Zhang, Beijing (CN); Shaohua Liu, Beijing (CN)

(72) Inventors: Pin Wu, Beijing (CN); Hai Zhou, Beijing (CN); Yuliang Shen, Beijing (CN); Houwei Xing, Beijing (CN); Heng Zhang, Beijing (CN); Shaohua Liu, Beijing (CN)

(73) Assignees: China National Petroleum Corporation, Beijing (CN); Zhongcheng Machinery Manufacturing Co., Ltd. of Bohai Petroleum Equipment, Tianjin (CN); CNPC, Bohai Equipment Manufacturing Co., Ltd, Tianjin (CN)

(21) Appl. No.: 14/232,854

(22) PCT Filed: Jun. 15, 2012
(86) PCT No.: PCT/CN2012/000835

§ 371 Date: Apr. 25, 2014

(30) Foreign Application Priority Data
Jul. 15, 2011 (CN) 201110198469.7

(51) Int. Cl. F16D 1/04

(52) U.S. Cl. CPC F16D 1/04
USPC 403/337

(57) ABSTRACT

The invention relates to a centrifugal pump connection device for electrical submersible pump unit; two or more centrifugal pumps are fixedly connected successively from top to bottom, the lower end of a centrifugal pump body being a connecting flange and a rabbet at the lower end of the connecting flange inserting in the upper inner bore of an adjacent centrifugal pump body, the contact surface between the connecting flange and the centrifugal pump body is a spherical surface, and the used washer of a bolt is a disc washer; the spherical surface of the connecting flange is a convex spherical surface, and the spherical surface of the upper end of the centrifugal pump body is a concave spherical surface. The device has the following benefits: it has reasonable structure, being able to improve the overall flexibility of the electrical submersible pump unit, and to increase success rate of the electrical submersible pump unit descending into horizontal well and highly-deviated well and durability of the electrical submersible pump, and to largely decrease production cost. The present invention overcomes deficiencies of plastic deformation and breakage of the unit housing and breakage of connection bolts during the process of the electrical submersible pump unit descending into the horizontal well and highly-deviated well, in which flat flange, common spring cushion and bolt are used between conventional centrifugal pumps.

### BACKGROUND OF THE INVENTION

1. Field of Invention

The invention relates to an electrical submersible pump unit, especially relates to a centrifugal pump connection device of electrical submersible pump unit, particularly a centrifugal pump connection device of electrical submersible pump unit suitable for production operation in horizontal wells.

2. Related Art

Since horizontal well technology overcomes such deficiencies that vertical well drills through little number of oil layers and has low success rate, and has concentrated and free ground (or platform) well location points, it can efficiently improve production capability and recovery efficiency of oil wells, which is a major form of offshore drilling and also would be the main development trend of future onshore drilling. With continuous increasing requirement of oil and constant development of directional well technology, the application scopes of highly-deviated well and horizontal well become more and more broad. In various artificially lifted oil extraction equipments, the electrical submersible pump unit is the main lift means of production of horizontal well and highly-deviated well. The electrical submersible pump unit often is successively composed of two or more centrifugal pumps and separator, protector, submersible motor pump. Currently, the parts of the electrical submersible pump unit are connected by flat flanges using bolts and common spring cushions, and because of particular wellbore configuration (flexural point) of the horizontal well and particular shape of the electrical submersible pump (slender coupling structure), when descending into well through “the dog-leg” of oil well and angle buildup section, the housing of the electrical submersible pump unit is often subjected to local plastic deformation and breakage or the connection bolts are subjected to breakage, resulting in the unit damaged or dropping into well, which further effects normal process of production and causes economical lost.

### SUMMARY OF THE INVENTION

The invention intends to provide a centrifugal pump connection device for electrical submersible pump unit, which overcomes the problems of plastic deformation and breakage of the unit housing and breakage of connection bolts during the process of the electrical submersible pump unit descending into the horizontal well and highly-deviated well, in which flat flange, common spring cushion and bolt are used between conventional centrifugal pumps.

The centrifugal pump connection device for electrical submersible pump unit of the present invention comprises connecting flanges, bolts and washers; two or more centrifugal pumps are fixedly connected successively from top to bottom, the lower end of a centrifugal pump body being a connecting flange and a rabbet at the lower end of the connecting flange inserting in the upper inner bore of an adjacent centrifugal pump body, and the bolts are connected to axial bolt holes of the lower centrifugal pump body through radially distributed holes of the connecting flange of the upper centrifugal pump body, the contact surface between the connecting flange and the centrifugal pump body is a spherical surface and the used washer of a bolt is a disc washer; the spherical surface of the connecting flange is a convex spherical surface, and the spherical surface of the upper end of the centrifugal pump body is a concave spherical surface.

### BRIEF DESCRIPTION OF THE DRAWINGS

FIG. 1 is a schematic diagram of structure of centrifugal pump connection device for electrical submersible pump unit.

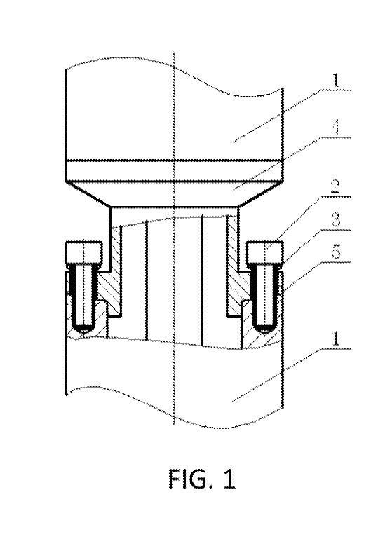

In the FIGURE: 1—centrifugal pump body, 2—bolt, 3—disc washer, 4—connecting flange, 5—spherical surface.

### DETAILED DESCRIPTION OF THE INVENTION

The invention describes a centrifugal pump connection device for electrical submersible pump unit, wherein the electrical submersible pump unit comprises two or more centrifugal pumps fixedly connected successively from top to bottom, the necking end at the lower end of a centrifugal pump body 1 being a connecting flange 4, a rabbet at the lower end of the connecting flange 4 inserting in the upper inner bore of an adjacent centrifugal pump body 1, the contact surface between the connecting flange 4 and the centrifugal pump body 1 is a spherical surface 5; the spherical surface of the connecting flange 4 is a convex spherical surface, and the spherical surface 5 of the upper end of the centrifugal pump body 1 is a concave spherical surface. The bolts 2 are connected to axial bolt holes of the lower centrifugal pump body 1 through radially distributed holes of the connecting flange 4 of the upper centrifugal pump body 1, and the used washer of a bolt 2 is a disc washer 3.

### INDUSTRIAL APPLICABILITY

On basis of that the parts of the electrical submersible pump unit are connected in series, the invention applies spherical fit at the connection of centrifugal pumps, and disc washer at connection bolts, resulting in the connection may freely rotate a certain angle relative to axis, and the overall electrical submersible pump unit has certain flexibility. When the electrical submersible pump unit operates in the horizontal well or highly-deviated well, it can smoothly pass through “the dog-leg” of oil well and angle buildup section, avoiding plastic deformation and breakage of the electrical submersible pump unit, increasing the success rate of the electrical submersible pump unit descending into the horizontal well or highly-deviated well, and extending operation time of the electrical submersible pump unit.

The invention has the following benefits: it has reasonable structure, being able to improve the overall flexibility of the electrical submersible pump unit, and to increase success rate of the electrical submersible pump unit descending into horizontal well and highly-deviated well and durability of the electrical submersible pump, and to largely decrease production cost.

What is claimed is:

1. A centrifugal pump connection device tor electrical submersible pump unit, comprising connecting flanges, bolts and washers, wherein two or more centrifugal pumps are fixedly connected successively from top to bottom, the lower end of a centrifugal pump body being a connecting flange and a rabbet at the lower end of the connecting flange inserting in the upper inner bore of an adjacent centrifugal pump body, and the bolts are connected to axial bolt holes of the lower centrifugal pump body through radially distributed holes of the connecting flanges of the upper centrifugal pump body, characterized in that: the contact surface between the connecting flange (4) and the centrifugal pump body (1) is a spherical surface (5); and the used washer of a bolt (2) is a disc washer (3).

2. The centrifugal pump connection device for electrical submersible pump unit according to claim 1, characterized, in that: the spherical surface (5) of the connecting flange (4) is a convex spherical surface, and the spherical surface (5) of the upper end of the centrifugal pump body (1) is a concave spherical surface.
